(19) United States
(12) Patent Application Publication
(10) Pub. No.: US 2008/0198765 A1
(43) Pub. Date: Aug. 21, 2008

(54) Signal Interconnection System

(76) Inventor: Giovanni Pirrone, Potenza (IT)

Correspondence Address: Young & Thompson, 745 S. 23rd Street., Second Floor, Arlington, VA, 22202, US

(21) Appl. No.: 11/917,024

(22) PCT Filed: Jun. 9, 2006
(86) PCT No.: PCT/IT2006/000435

§ 371 Date: Dec. 10, 2007

(30) Foreign Application Priority Data
Jun. 10, 2005 (IT) RM2005A000299

(51) Int. Cl. H04L 12/28; G01S 5/02

(52) U.S. Cl. 370/254; 370/276

(57) ABSTRACT

The present invention relates to a signal interconnection system (1) characterised in that it comprises at least a programmable central unit (2), a first plurality of peripheral units, connected to said at least a central unit, and suitable to store and/or manage and/or generating data and/or different signals, one ore more remote units (3), a number of a second plurality of peripheral units corresponding to the number of said one or more remote units, and connected to the respective remote unit, and bi-directional communication means (4) between said at least one central unit (2) and said one or more remote units (3); said at least on central unit (2) handling access of said remote units to functions and to said data and/or signals of said first plurality of peripheral units, and coordinating by said communication means (4) transmission of said data and/or signals of said first plurality of peripheral units and of said accesses substantially at the same time from/to one or more remote units (3); said one or more remote units (3) sending said data and/or signals to said second plurality of peripheral units.

The present invention relates to a signal interconnection system.

More specifically, the invention concerns a system studied and realised particularly for permitting interconnection among different apparatuses, transferring a plurality of different signals on a single cable.

As it is well known, at present, different cables are necessary for sending different kind of signals. This kind of connection is known as “point-point connection”.

Therefore, it is rather complicated making signal with different bandwidth, and with different tension (e.g. 48V of telephone connections) passing through a single cable,

For example, audio signals require the use of cables for balanced or unbalanced connections, thus more or less sensitive to noises and ground noises. Data exchanged between two or more computers connected along a network require specific cables and the same signals passes through devices (hubs, switches) intervening in treatment of the same signals.

Generally speaking, it is possible saying that all signal mentioned in the above require a different cable, since each of them has different physical properties and is handled by different electronic devices.

At present, for realising systems for transporting different kind of signals by different cables it is necessary laying down said cables within different tubes, either due to technical reasons, since presence of different cables within the same tubes can cause noises (mainly of the electro-magnetic type) and to rule requirements.

Obviously, this involves high system installation costs, both for installation and maintenance, also in view of the complexity of the system.

It is further known that at present many apparatuses are provided, each one capable making one or more functions, but each one “not linked” with the other one, and the daily managing of the same is complex and often complicated, not for those skilled in the field, but surely for the final users, without differences on the basis of the cultural level.

Object of the present invention is therefore that of suggesting a signal interconnection system for apparatuses permitting a technological simplification and integration.

A second object of the present invention is that said system permits contemporaneous and bi-directional sharing on a single cable of different type signals, such as data, audio, video, telephone-intercommunication system, alarms.

Another object of the present invention is that above system, comprised of a central unit and of one or more remote units, can be used both in the civil and industrial fields and permits an easy updating and maintenance.

It is therefore specific object of the present invention a signal interconnection system characterised in that it comprises at least a programmable central unit, a first plurality of peripheral units, connected to said at least a central unit, and suitable to store and/or manage and/or generating data and/or different signals, one ore more remote units, a number of a second plurality of peripheral units corresponding to the number of said one or more remote units, and connected to the respective remote unit, and bidirectional communication means between said at least one central unit and said one or more remote units; said at least on central unit handling access of said remote units to functions and to said data and/or signals of said first plurality of peripheral units, and coordinating by said communication means transmission of said data and/or signals of said first plurality of peripheral units and of said accesses substantially at the same time from/to one or more remote units; said one or more remote units sending said data and/or signals to said second plurality of peripheral units.

Furthermore, according to the invention, said at least one central unit can comprise stored structural information concerning planimetry and features of the building where it is provided; and in that it provides a communication unit that can be connected with said central unit by wireless connection means, provided with interface means, such as a display, and suitable to acquire said structural information; and a plurality of portable transceivers for first aid operators, said transceivers can be coupled with said first and/or second plurality of peripheral units by wireless connection means, so as to permit localisation of each one of said operators within said building by said communication unit.

Advantageously, according to the invention, said at least one central unit can comprise a protected mass memory unit for memorisation of said structural information.

Always according to the invention, said system can comprise a plurality of central units connected by communication means.

Still according to the invention, each one of said central units can access the peripheral units of the other central units.

Furthermore, according to the invention, said at least one central unit and said one or more remote units can comprise a switching device suitable to permit transceiving of said signals.

Advantageously, according to the invention, said central unit and said one or more remote units can comprise a network control device and/or a data exchange interface.

Still according to the invention, said system can comprise a shunting unit, suitable to be provided between said central unit and said one or more remote units, comprising a switching device and/or at least a network control device.

Preferably, according to the invention, said central unit can comprise a hard disk.

Always according to the invention, said system can comprise an audio signal-processing module, suitable to convert synchronous data into isochronous data and vice versa.

Furthermore, according to the invention, said audio signal processing module can transmit signal according to a signal bundle mode.

Still according to the invention, said audio signal processing module can comprise a signal digital processor.

Always according to the invention, said audio signal processing module can comprise a digital/analogical—digital/digital converter and/or a programmable unit.

Advantageously, according to the invention, said audio signal processing module can comprise signal storage and/or mixing means.

Furthermore, according to the invention, said system can comprise a video signal-processing module.

Always according to the invention, said video signal processing module can comprise a video signal digital processor.

Still according to the invention, said system can comprise a load control device.

Advantageously, according to the invention, said load control device can be suitable to measuring electric loads and is connected with the electric energy meter, and, by said one or more remote units, with at least a absorption sensor connected with at least a white good.

Always according to the invention, said absorption sensor can comprise an actuator suitable to interrupt supply to said at least a white good.

Furthermore, according to the invention, said sensor can be connected with said remote unit by cable and/or by wireless connection.

Still according to the invention, said peripheral units connected with said central unit can comprise internet connection means and/or radio-frequency transceiving means and/or Video Disc Digital (DVD) reader and/or a standard telephone network and/or a video board, and/or a satellitar receiver and/or a radio-frequency receiver and/or a fire alarm and/or an anti-intrusion alarm.

Advantageously, according to the invention, said system can comprise a telephone interface.

Furthermore, according to the invention, said peripheral units connected with one or more remote units comprise transduction means, such as audio amplifier and speakers.

Preferably, according to the invention, said transduction means can comprise a monitor and/or a TV apparatus and/or an acoustic boozer.

Always according to the invention, said peripheral units connected with said one or more remote units can comprise gas and/or fire sensors.

Still according to the invention, said peripheral units connected with said one or more remote units can comprise sanitary and/or electro-medical control devices.

Further, according to the invention, said central unit and/or said remote unit can comprise interface means, such as a keyboard and/or a display and/or a computer and/or a remote control.

Always according to the invention, said communication systems can comprise a network cable, comprising at least a control data cable and/or at least a clock cable and/or at least a standard data traffic cable and/or at least an isochronous data cable.

Still according to the invention, said connection means can comprise a wireless connection system, such as a radio frequency and/or infrared connection system.

The present invention will be now described, for illustrative but not limitative purposes, according to its preferred embodiments, with particular reference to the figures of the enclosed drawings, wherein:

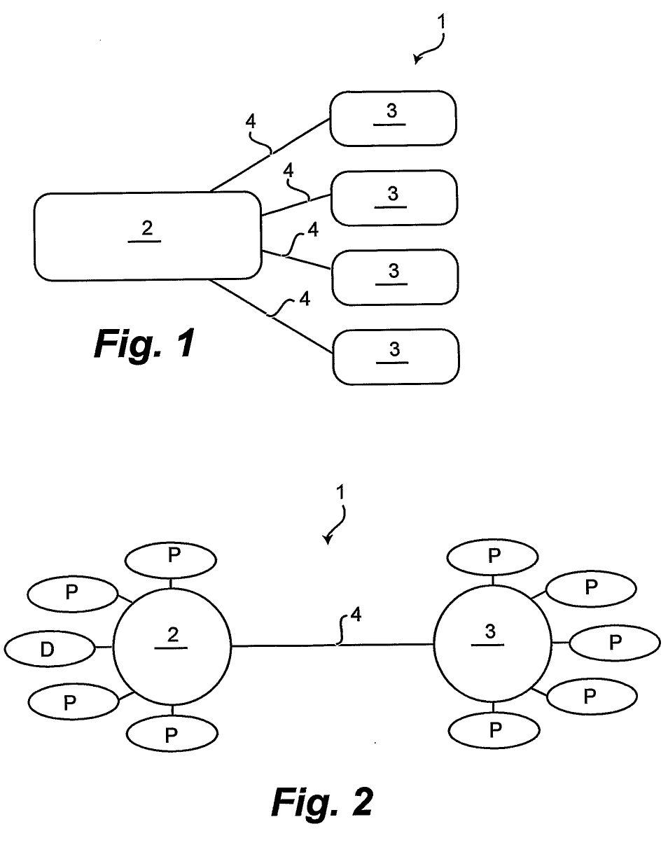

FIG. 1 is a block diagram of the signal interconnection system according to the present invention;

FIG. 2 is a block diagram of the signal interconnection system between a central unit and a remote unit;

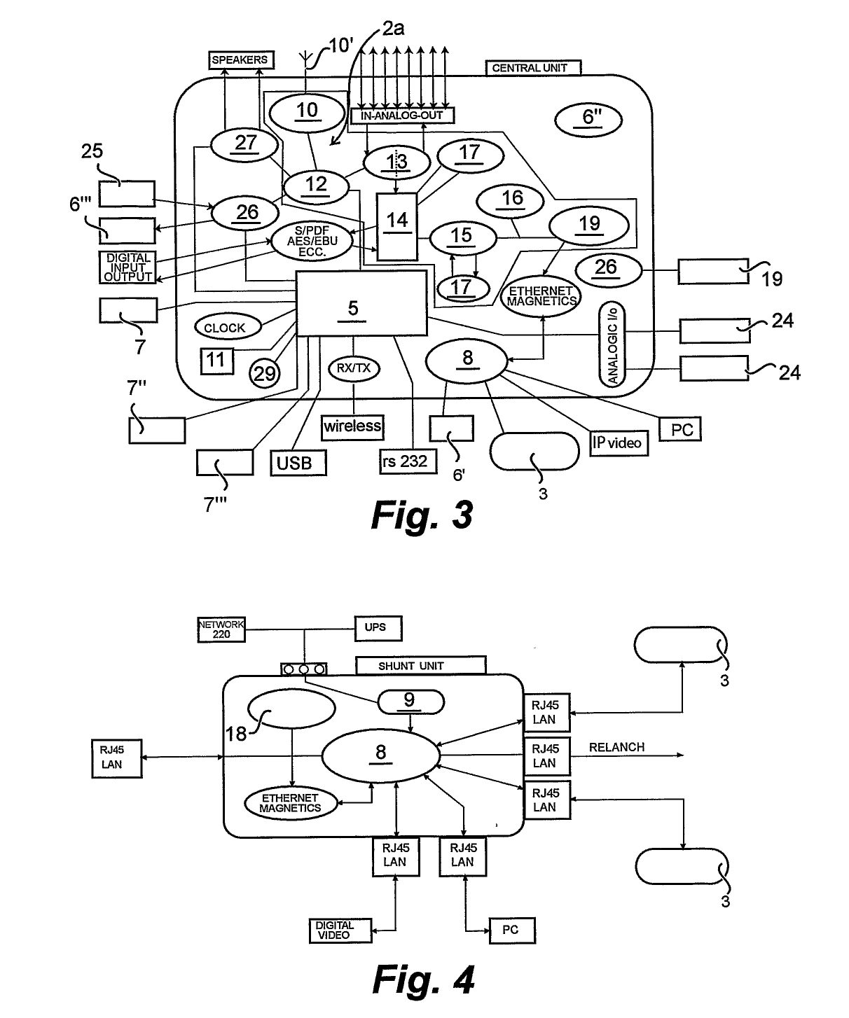

FIG. 3 is a block diagram of central unit;

FIG. 4 is a block diagram of a shunting unit;

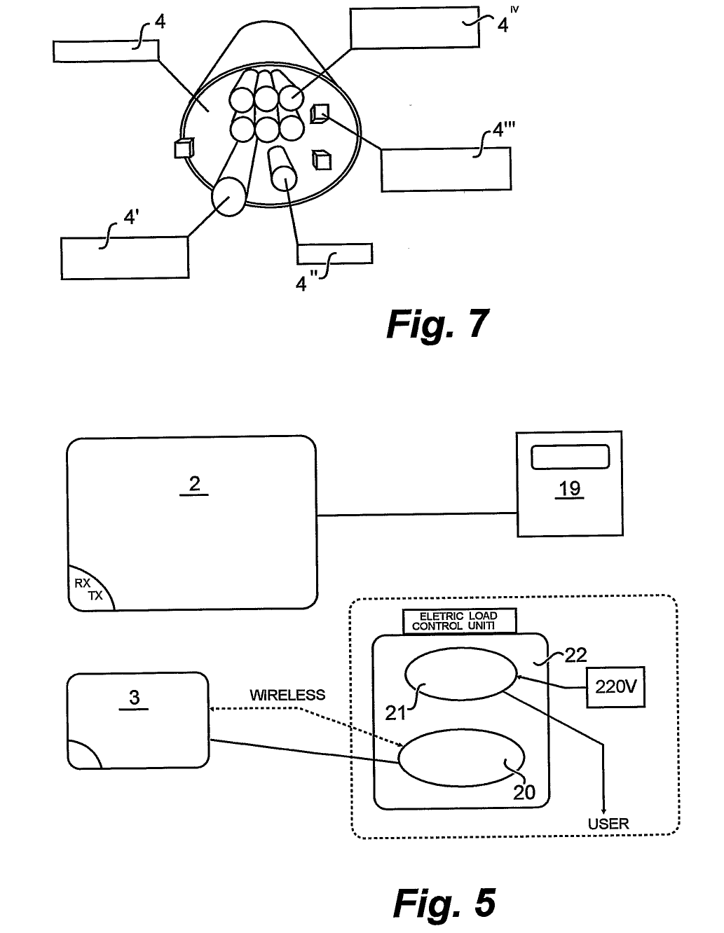

FIG. 5 shows a circuit scheme of operation of electric load control module;

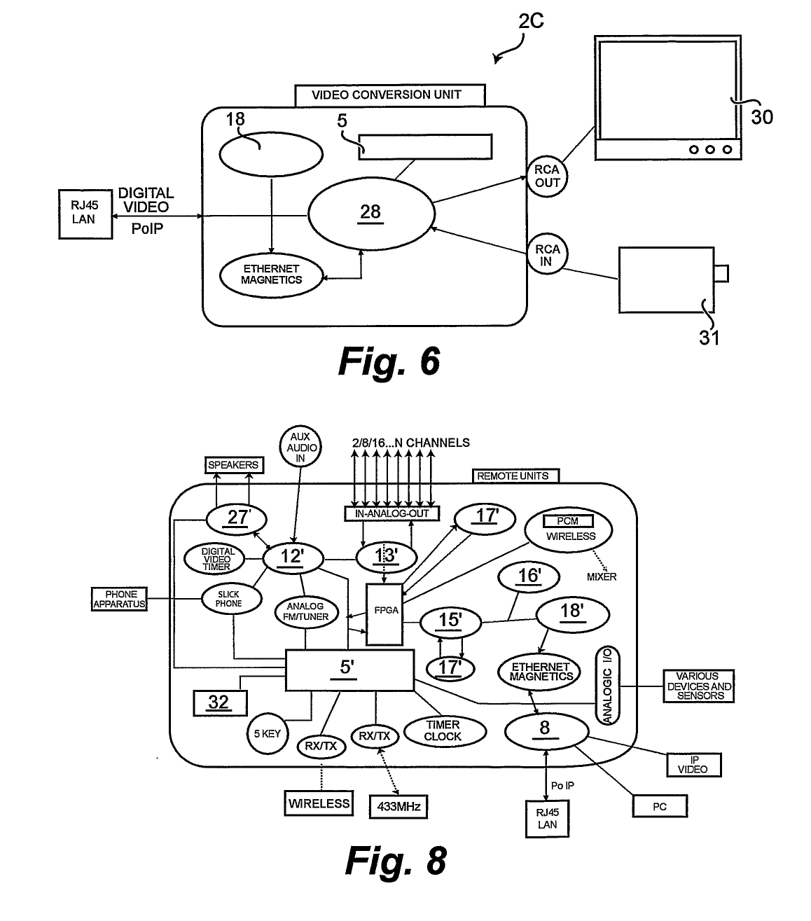

FIG. 6 shows a video signal-processing module for a central unit;

FIG. 7 shows section of an Ethernet connection cable;

FIG. 8 is a block diagram of a remote unit;

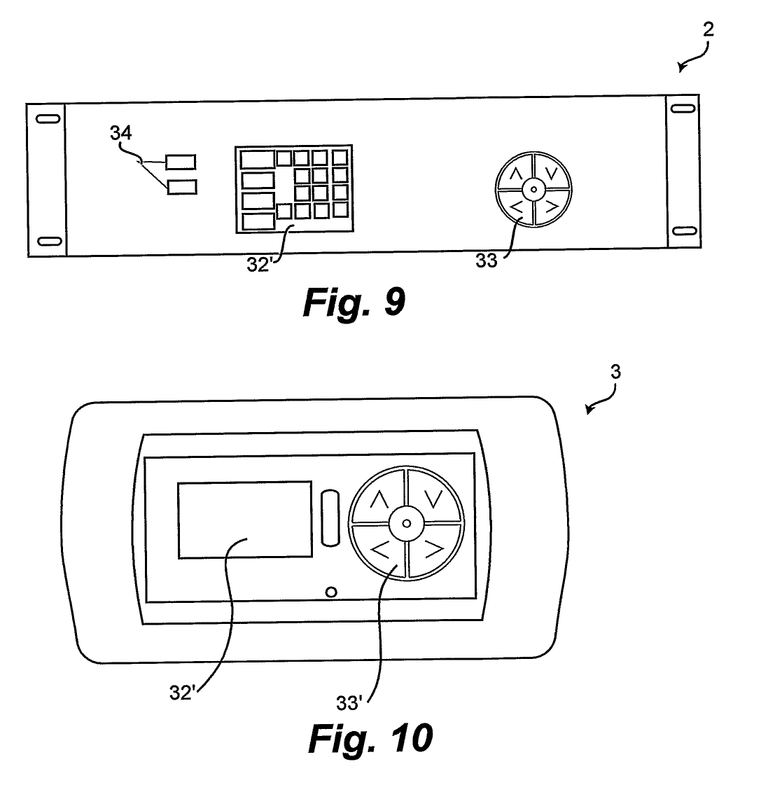

FIG. 9 shows an embodiment of the central unit;

FIG. 10 shows an embodiment of the remote unit; and

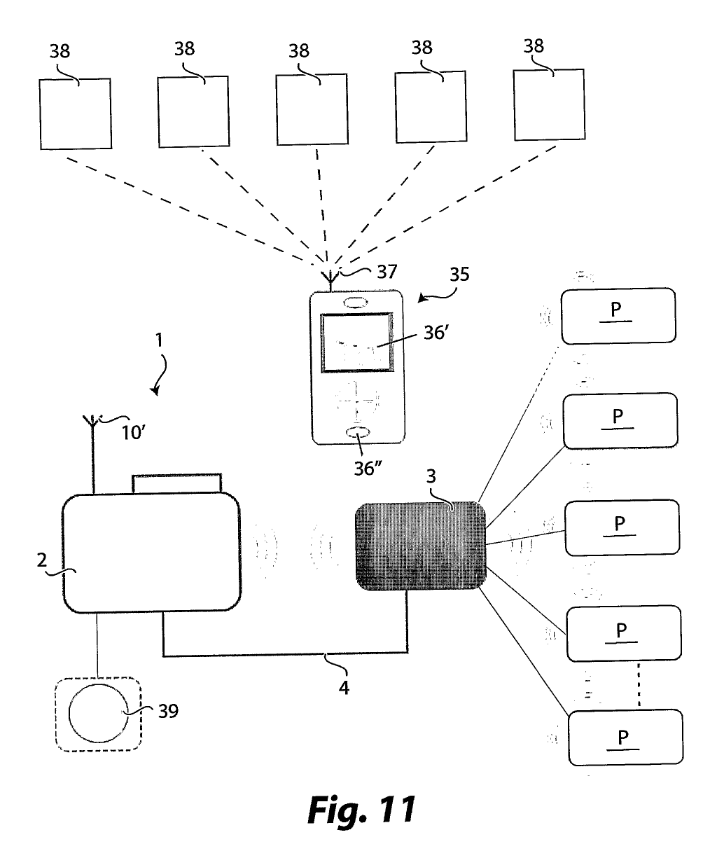

FIG. 11 is a block diagram of a further embodiment of the signal interconnection system according to the present invention.

Making reference to FIG. 1, it is shown a scheme of system 1 according to the present invention. Said system 1 mainly comprises a central unit 2 and a plurality of remote units 3.

Said central unit 2 and said plurality of remote units 3 are connected by Ethernet cable 4, the inner structure of which will be described in the following.

Examining FIG. 2, it is possible observing that a plurality of different peripheral units P (video, audio, telephone, data, . . . ) is connected to central unit 2 and to each remote unit 3.

By system 1, it is possible managing (bidirectional) transmission of signals coming from said heterogeneous peripheral units P, by said single network wire 4.

As a function of the use fields (domestic, industrial, hotel industry, hospital field), specific software will be used for programming said central unit 2 and said remote unites 3.

Examining now FIG. 3, it is possible evaluating in greater detail central unit 2. it provides inside a microprocessor or CPU 5, installed within a motherboard.

Said central unit 2 can interact with remote units 3, with other central units 2 or with outside by connection means 6, such as an ADSL router 6′, a GSM module 6′ or a standard telephone line 6″, extending this capability to the remote units 3.

Furthermore, user will have the possibility of using a dedicated area of the system, in order to personalise one or more web pages to remote control events and functions either of central unit 2 and of remote units 3 connected to the central units and of peripheral units P.

Interface peripheral unit 7 (VGA video board 7′, mouse 7″, keyboard 7′″, USB 7^{IV}, ecc.), suitably designed 100 Mbit/sec LAN network switching device 8 (self-negotiating and full duplex), permitting connecting a plurality of LAN devices to the local network, are integrated in local network.

Other switching devices are added to said switching device 8, provided within shunt boxes 2′ (see FIG. 4), in case a plurality of remote units are connected. Generally speaking, all remote units must be connected with switching devices 8 according to a “star” mode. A plurality of switching devices 8 can be cascade connected in order to increase number of remote units that can be connected.

In order to use the invention in more wide systems, it is necessary, as already said, providing shunt units 2′, as shown in FIG. 4. Said units provide switching devices 8 similar to the one provided within central unit 2, a means 9 for supplying remote units 3 are provided.

Central unit 2, on the basis of the specific use, will be provided with a plurality of connectors for connection with other peripheral units P. An embodiment can provide an audio/video driver, a digital radio frequency receiver 10 provided with antenna 10′. Furthermore, same unit 2 is provided with a suitable hard disk 11 for storing data, video, music audio, and more generally multimedia files.

Said central unit 2 provides various modules at the operative level. The first one is the audio signal processing module 2a.

Inlet or outlet analogical audio signals are sent to a mixer 12, addressing them, after processing (adjustment of level, tone, ecc.) to digital/analogical—digital/digital converters 13 handled by a programmable unit 14 (FPGA) containing the logic interface among module components 2a.

In this embodiment, audio signal processing module 2a uses a digital signal processor 15 (DSP—Digital Signal Processor) permitting sending in real time digital audio signals (resolution 16-20-24 bit and sampled at 48 kHz) on Ethernets.

Module 2a (comprised of digital signal processor 15, flash memory 16, crystal oscillator 15a, Ethernet control device 18) makes data conversion from synchronous into isochronous and vice versa, permitting (real time) data formatting and transportation on network. Said data can be controlled and monitored by an SNMP protocol.

Audio signal is transferred on network according to a beam mode. Each beam can comprise from 0 to 8 audio channels. Flash memory 16 adjusts managing variables of digital signal processor 15 containing inside SRAM memory wherein audio buffers and network protocols are maintained, permitting from synchronous into isochronous and vice versa. Sampling clock is generated by crystal oscillator 15a controlled by digital signal processor 15, controlling frequency in order to make synchronism with network clock.

Furthermore, digital signal processor 15 is provided with an 8 bit bidirectional gate for interfacing a possible further processor, being read as a peripheral unit.

Microprocessor “sees” digital signal processor “Host” gate as a group of eight registers: four for control and state functions and the others for transferring data from microprocessor to sub-system.

Central unit 2 also provides a module for controlling electric wires 2b, suitable to manage white goods. This particular function is enabled when one or more remote units 3 is connected, by wire 4 or by wireless system or by absorption sensor 20 and actuator 21, e.g. coupled with the supply socket 22, with more common white goods (washing machine, oven, kitchen, refrigerator, dishwashing machine, heater, air conditioner), or with any other device absorbing energy, even mechanical devices.

Making reference to FIG. 5, it is noted that central unit 2 will also connect with meter 19 provided by electric energy supplier, in case the latter is ready to provide control of complete energy absorption. Central unit 2 handles information relevant to electrical loads from remote units 3, switching on and switching off relevant apparatuses, so as to avoid involuntary interruption of supply, caused by overloading or other failures.

A circuit combining two digital/digital converters 13, having the function of calculating power, and a serial interface, determines operation.

Central unit 2 measures and calculates on a single phase (to or three wires), instantaneous power, IRMS current, VRMS tension and real power. Circuit interfaces with a shunt resistance or with a transformer (not shown in the figures) for measuring current and a resistive divider or potential transformer (not shown in the figures) for measuring tension.

Bi-directional, serial interface communicates with microprocessor 5 and with a converter provided with impulsive exit, so that average impulsive frequency is proportional to real power.

Furthermore, circuit is provided with “self-ignition” so that it is independent from the control of central unit. This is obtained by a programmable memory (not shown in the figure), such as an EEPROM, permitting autonomously varying said module 2b, directly implementing it in white goods or in a separate module.

Central unit 2 also provides an inlet/outlet module 23 for digital/digital interface, suitable to connection with outside (anti-intrusion, anti-fire, ecc.) alarm units or devices 24.

Furthermore, said central unit 2 provides possibility of interfacing with traditional analogical telephone line. Telephone line is connected with central unit 2 by a connector for local telephone line 25.

Audio and other signals such as bells are sent on LAN network through audio signal processing module 2a, and thus distributed to all remote units 3. remote unit 3 is alerted by central unit 2 about arrival of the call, said signal is localised and first telephone raised occupies the line and thus audio channel allocated to the audio signal processing module 2a.

For outgoing call, first telephone raised occupies channel of audio signal processing module 2a, allocated to telephone service and connected with line connected with central unit 2. other remote units 3 receive a signal indicating that telephone line is off-hook.

An increase of number of telephone lines controlled is obtained by adding an audio expansion module (not shown in the figure) inputting other telephone lines in the audio signal processing module 2a flow. Everything is managed by central unit 2 governing priorities and availability of lines, in any case maintaining the intercommunication system function enabled.

Entering local telephone line 25 is uncoupled with a transformer (not shown in the figure), sent to the analogical circuit realising the “telephone fork” and sent to interface 26 transceiving connectors (SLIC—Subscriber Line Interface Circuit) replacing the function of the analogical transformer. Telephone line coupling/uncoupling circuit is connected with said interface 26. realised with a relays communicating with an outlet of the interface 26, preferably by a phototransistor. This outlet is enabled for loop currents higher than 10 mA and disenabled for currents lower than 5 mA. Microprocessor 5, which is connected to the same exit, determines its use.

Interface 26 further generates negative tension received from a tension converter (not shown in the figure) from +12V to −48V, providing “TIP & RING” analogical inlets for receiving voice signals from telephone and possibly monitor the same on the system.

Finally, central unit 2 provides a video signal processing module 2c, shown separated in FIG. 6. Said video signal processing module 2c provides a MPEG decoding module, that can locally produce digital video signals arriving from digital video driver DVD 29 from other sources connected with central unit 2.

Generally speaking, it will be possible providing every apparatus on LAN connection distributing video on LAN and thus every apparatus that can receive and decoding a video signal, e.g. a processor or a monitor 30.

Video digital driver 29 is shared on the network ad thus can be reached from outside, e.g. from remote units or from a processor. In other words, it is possible reaching central unit 2 (by a browser or network in case a computer is provided), reaching the video digital driver 29, sending it the signal for reproducing the movie.

Outlet data from video digital driver 29, MPEG or AVI format, are transformed into IP format and then transferred in the network. Receiving unit takes data from IP protocol, decoding the same from MPEG or AVI or other format and represents the same on computer monitor 30. As alternative, it is possible using other units in lieu of computer, converting data into composite video signal to be sent on the video or analogical monitor.

Said video signal processing module 2c can be connected with an analogical camera 31.

A section of an Ethernet wire is shown in FIG. 7. particularly, it can be noted control data wire 4′, clock 4″, data standard traffic wire 4′″ and isochronous data wire 4^{IV}.

Suitable protocols are used to transmit data. Particularly, according to the present embodiment, it is provided a protocol fully compatible with IEEE 802.3 standard protocol as far as isochrone signals are concerned, while a different protocol is provided for all other data. It is possible providing the use of a single protocol.

Making reference to FIG. 8, it is possible observing block diagram of a remote unit 3.

Said unit 3 integrates most functions and electronics of the central unit 2 with which colloquia. It can exchange data, at the same time and bi-directionally, with other remote units 3 and, by the central unit 2, also with outside environment.

Remote unit 3 can be implemented in different formats, such as a built-in box or a table, ceiling or wall container, or a portable container.

Remote units can be identified by TCP/IP protocol and allocation can manually occur by the same remote unit 3 or by the central unit 2, or automatically always by the central unit 2.

Remote unit 3 contains audio signal processing module 3a, fully equivalent to module 2a, a micro controller 5′, controlling a display 32′, bus functions relevant to mixer controls 12′, a video signal processing module 3e, input/output functions toward central unit 2 and a serial interface.

Outlet from digital/analogical converter is sent to an integrated stereo amplifier 27′.

Remote unit 3 will be usually in a waiting mode, and will switch on due to pressure of a button when it will receive a pulse from a remote control (not shown in the figure), upon request of the central unit 2, or when it is, intentionally, or automatically, activated the alarm signal.

Remote unit 3 controls alarm radio sensors 24, analogical or digital sensors for detection of temperature, humidity, gas, smoke, fire, ecc., that can be installed within the environment and connected by wire or by radio.

It is further provided an interface 17′ for data exchange, with compatible peripheral units, that in this embodiment is an IRDA interface.

A button for aid call is also provided on remote unit 3. Central unit 2 programs functions relevant to the “aid” situation.

When applying the system 1 in hotels, hospitals, ecc., it is possible providing a clock alarm function that can be activated by central unit 2, for example installed at reception.

When ADSL connection of central unit 2 is activated, a particular software function permits detecting and making available radio programs and Internet both on central unit 2 and on remote units 3.

In view of its very small dimensions, remote unit 2 can be integrated in apparatuses, such as car radio set. Furthermore, taking into consideration always more low costs of connection by mobile telephone network, user can obtain a direct connection with environment where the interconnection system according to the invention is installed, e.g. home, office, ecc., remote controlling the same.

Therefore, it will be possible activating all apparatuses directly connected with central unit or other remote units, but it will also possible managing functions and displaying in real time “responses” of the same apparatuses. Otherwise, it will be possible listening a music track, seeing a movie, ecc., simply taking it from central unit 2 and listening the same track, for example, on the motor vehicle or other remote apparatus.

In the domestic—sanitary field (disable assistance, ecc) or mainly sanitary (hospitals), remote units 2 can be handling all control services needed by the patient. Therefore, it will be possible monitoring vital functions (using specific sensors), and creating alarm signals, according to the various personnel levels, that can directly or indirectly activate suitable apparatuses or other sensors by said central unit or by said remote unit.

In the domestic field, thanks to the capability of the system to send audio signals according to a bidirectional mode and in real time, it will be possible for example, while one of the stereo audio channels is listened from one remote unit 3, sending one or more signals toward the central unit 2, that can be available also on the other remote units 3.

In the hotel industry field, beside diffusing video and/or digital TV signal and music within rooms, remote units 3 can perform all functions for controlling environment comfort, such as switching on and switching off heating and conditioning system activating pay services (e.g. movies, telephone calls, ecc.), programming clock alarm with a music track, speaking with reception or with remote units 3 of other rooms, activating different alarms.

Finally, FIGS. 9 and 10 show an embodiment of the central unit 2 and of remote unit 3.

Particularly, central unit 2 shown in FIG. 9 shows display 32 and a button panel 33, along with USB gates 34.

FIG. 10 shows a remote unit 3 providing a display 32′ and button panel 33′.

Central unit 2 sends, on the basis of the user choices, option menu on corresponding remote unit 3 display 32′. As already mentioned, remote unit 3 can be also controlled by a remote control.

Being central unit 2 and remote units 3 programmable, it is possible updating system functions 1 both at the program level and at the controlled device level.

FIG. 11 shows a further embodiment of system 1 according to the invention. Central unit 2 and/or remote units 3 can be connected with a wireless communication unit 35, provided with monitor 36′, microphone 36″ and an antenna 37, and a series of transceivers 38.

Central unit 2, besides making the above functions (bi-directional communication for controlling and handling light, temperature, ecc.) permits communicating, by a specific protocol, with personnel coordinating aids within a building in case of emergency (fire, natural events, ecc.).

In case a fire occurs within a hotel and firemen arrive, whole building planimetry, along with anti-fire plan and all data typical of managing this kind of event, is stored when installing central unit 2, and for safety reasons also in a suitably protected mass memory unit 39,

These information and data are sent, when personnel and aids arrive, to said communication unit 35 placed on an aid means and enabled to recognise communication protocol.

Said communication unit 35 will display data received on said monitor 36 (planimetry, . . . ). Furthermore, each operator (e.g. fireman), besides standard communication means, will be provided with said transceiver 38, that can wireless connect with peripheral units P (control devices, electrical outlets, white goods, video, audio, data devices, ecc.). The latters, along with the central unit 2, can determine position of each single operator provided with said transceiver 38. When each operator has been individuated by said peripheral units P (even if some peripheral units are destroyed by fire, those still operating can detect the same), central unit 2 sends information acquired by peripheral units P of each transceiver 38 to said communication unit 35, thus permitting to those co-ordinating emergency operations to know the position of each operator. This permits coordinating aid intervention, rationally positioning operators, thus avoiding, as it often occurs, that, due to the smoke, operators cannot “see” each other, thus slowing down and thus making impossible ready aid action.

Furthermore, suitably installed units P determine physical position of static element of building within which each of them is positioned, thus permitting a real vision of operative safety conditions (e.g. broke down stairways, destroyed walls, blocked elevators, ecc.). A specific software suitably developed, permits managing events and system.

On the basis of the previous specification, it can be noted that basic feature of the present invention is possibility of using by remote units 3 resources connected and controlled by a central unit 2 and possibility of remote reaching and controlling system by connection with said central unit 2.

An advantage of the present invention is that of permitting remarkable saving under the system point of view, since it permits remarkable savings as far as laying and number of wire necessary for wiring building, naval, ecc structures are concerned, mainly in case of new system.

A further advantage of the present invention is the fact that interconnection system can be installed within already wired structures with available network wires, thus not being necessary making relevant changes to the already existing systems, thus permitting renewing already existing structures without additional costs (materials and working days).

Another advantage of the invention is that permits controlling managing of absorbed electric power according to different consumption levels.

The present invention has been described for illustrative but not limitative purposes, according to its preferred embodiments, but it is to be understood that modifications and/or changes can be introduced by those skilled in the art without departing from the relevant scope as defined in the enclosed claims.

1. Signal interconnection system characterised in that it comprises at least a programmable central unit, a first plurality of peripheral units, connected to said at least a central unit, and suitable to store and/or manage and/or generating data and/or different signals, one ore more remote units, a number of a second plurality of peripheral units corresponding to the number of said one or more remote units, and connected to the respective remote unit, and bi-directional communication means between said at least one central unit and said one or more remote units; said at least on central unit handling access of said remote units to functions and to said data and/or signals of said first plurality of peripheral units, and coordinating by said communication means transmission of said data and/or signals of said first plurality of peripheral units and of said accesses substantially at the same time from/to one or more remote units; said one or more remote units sending said data and/or signals to said second plurality of peripheral units.

2. System according to claim 1, characterised in that said at least one central unit comprises stored structural information concerning planimetry and features of the building where it is provided; and in that it provides a communication unit that can be connected with said central unit by wireless connection means, provided with interface means, such as a display, and suitable to acquire said structural information; and a plurality of portable transceivers for first aid operators, said transceivers can be coupled with said first and/or second plurality of peripheral units by wireless connection means, so as to permit localisation of each one of said operators within said building by said communication unit.

3. System according to claim 2, characterised in that said at least one central unit comprises a protected mass memory unit for memorisation of said structural information.

4. System according to claim 1, characterised in that it comprises a plurality of central units connected by communication means.

5. System according to claim 4, characterised in that each one of said central units accesses the peripheral units of the other central units.

6. System according to claim 1, characterised in that said at least one central unit and said one or more remote units comprise a switching device suitable to permit transceiving of said signals.

7. System according to claim 1, characterised in that said central unit and said one or more remote units comprise a network control device.

8. System according to claim 1, characterised in that said central unit and said one or more remote units comprise a data exchange interface.

9. System according to claim 6, characterised in that it comprises a shunting unit, suitable to be provided between said central unit and said one or more remote units, comprising a switching device and/or at least a network control device.

10. System according to claim 1, characterised in that said central unit comprises a hard disk.

11. System according to claim 1, characterised in that it comprises an audio signal-processing module.

12. System according to claim 11, characterised in that said audio signal processing module converts synchronous data into isochronous data and vice versa.

13. System according to claim 11, characterised in that said audio signal processing module transmits signal according to a signal bundle mode.

14. System according to claim 11, characterised in that said audio signal processing module comprises a signal digital processor.

15. System according to claim 11, characterised in that said audio signal processing module comprises a digital/analogical—digital/digital converter.

16. System according to claim 11, characterised in that said audio signal processing module comprises a programmable unit.

17. System according to claim 11, characterised in that said audio signal processing module comprises signal storage means.

18. System according to claim 11, characterised in that said audio signal processing module comprises signal mixing means.

19. System according to claim 1, characterised in that said system comprises a video signal-processing module.

20. System according to claim 19, characterised in that said video signal processing module comprises a video signal digital processor.

21. System according to claim 1, characterised in that said system comprises a load control device.

22. System according to claim 21, characterised in that said load control device is suitable to measuring electric loads and is connected with the electric energy meter, and, by said one or more remote units, with at least a absorption sensor connected with at least a white good.

23. System according to claim 22, characterised in that said absorption sensor comprises an actuator suitable to interrupt supply to said at least a white good.

24. System according to claim 22, characterised in that said sensor is connected with said remote unit by cable and/or by wireless connection.

25. System according to claim 1, characterised in that said peripheral units connected with said central unit comprise Internet connection means.

26. System according to claim 25, characterised in that said peripheral units connected with said central unit comprises radio-frequency transceiving means.

27. System according to claim 25, characterised in that said peripheral units connected with said central unit comprises Video Disc Digital (DVD) reader.

28. System according to claim 25, characterised in that said peripheral units connected with said central unit comprises a standard telephone network.

29. System according to claim 25, characterised in that said peripheral units connected with said central unit comprises a telephone interface.

30. System according to claim 25, characterised in that said peripheral units connected with said central unit comprises a video board.

31. System according to claim 25 characterised in that said peripheral units connected with said central unit comprises a satellitar receiver and/or a radio-frequency receiver.

32. System according to claim 25, characterised in that said peripheral units connected with said central unit comprises a fire alarm and/or an anti-intrusion alarm.

33. System according to claim 1, characterised in that said peripheral units connected with one or more remote units comprise transduction means.

34. System according to claim 33, characterised in that said transduction means comprise audio amplifier and speakers.

35. System according to claim 33, characterised in that said transduction means comprise a monitor and/or a TV apparatus and/or an acoustic boozer.

36. System according to claim 33, characterised in that said peripheral units connected with said one or more remote units comprise gas and/or fire sensors.

37. System according to claim 33, characterised in that said peripheral units connected with said one or more remote units comprise sanitary and/or electro-medical control devices.

38. System according to claim 1, characterised in that said central unit and/or said remote unit can comprise interface means.

39. System according to claim 38, characterised in that said interface means comprise a keyboard.

40. System according to claim 38, characterised in that said interface means comprise a display.

41. System according to claim 38, characterised in that said interface means comprise a computer.

42. System according to claim 38, characterised in that said interface means comprise
a remote control.

43. System according to claim 1, characterised in that said communication systems comprise a network cable.

44. System according to claim 43, characterised in that said network cable comprises at least a control data cable and/or at least a clock cable and/or at least a standard data traffic cable and/or at least an isochronous data cable.

45. System according to claim 43, characterised in that said connection means comprise a wireless connection system.

46. System according to claim 45, characterised in that said connection means comprise a radio-frequency connection system.

47. System according to claim 45, characterised in that said connection means comprise an infrared connection system.

48. (canceled)
